(19) United States
(12) Patent Application Publication
(10) Pub. No.: US 2017/0126002 A1
(43) Pub. Date: May 4, 2017

(54) ESD PROTECTION AND LIMITER CIRCUIT

(71) Applicant: MACOM Technology Solutions Holdings, Inc., Lowell, MA (US)

(72) Inventor: Timothy Gittemeier, Holly Springs, NC (US)

(73) Assignee: MACOM Technology Solutions Holdings, Inc., Lowell, MA (US)

(21) Appl. No.: 14/925,839

(22) Filed: Oct. 28, 2015

(51) Int. Cl. H02H 9/04

(52) U.S. Cl. CPC H02H 9/044; H02H 9/046

(57) ABSTRACT

Electrostatic discharge protection circuits and methods of operation are described. An ESD circuit may include two circuit branches, each including a transistor, that are arranged to shunt voltage and current between two circuit terminals responsive to an over-voltage condition between the two terminals. A turn-on voltage of each transistor may be set by series-connected diodes.

### BACKGROUND

Technical Field

The technology relates to electrostatic discharge protection circuitry.

Discussion of the Related Art

Gallium-nitride semiconductor material has received appreciable attention in recent years because of its desirable electronic and electro-optical properties. Gallium nitride (GaN) has a wide, direct bandgap of about 3.4 eV that corresponds to the blue wavelength region of the visible spectrum. Light-emitting diodes (LEDs) and laser diodes (LDs) based on GaN and its alloys have been developed and are commercially available. These devices can emit visible light ranging from the violet to red regions of the visible spectrum.

Because of its wide bandgap, gallium nitride is more resistant to avalanche breakdown and can maintain electrical performance at higher temperatures than other semiconductors, such as silicon. GaN also has a higher carrier saturation velocity compared to silicon. Additionally, GaN has a Wurtzite crystal structure, is a very stable and hard material, has a high thermal conductivity, and has a much higher melting point than other conventional semiconductors such as silicon, germanium, and gallium arsenide. Accordingly, GaN is useful for high-speed, high-voltage, and high-power applications. For example, gallium-nitride materials are useful in semiconductor amplifiers for radio-frequency (RF) communications, radar, and microwave applications.

Even though gallium-nitride materials can be more resistant to avalanche breakdown, devices made from gallium nitride are still susceptible to damage from over-voltage conditions, which may occur, for example, by electrostatic discharge (ESD). Additionally, some devices (e.g., gallium-nitride based amplifiers) may benefit from over-voltage protection at their input, so that an amplifier receiving a high signal level is not damaged.

### SUMMARY

Circuits and methods for electrostatic discharge (ESD) and over-voltage protection are described. According to some embodiments, an ESD circuit includes parallel circuit branches coupled between two terminals. The parallel circuit branches may be configured to symmetrically shunt current between the two terminals responsive to over-voltage conditions appearing between the two terminals. Each branch includes a transistor that is switched on at a predetermined trigger level, which may be set by series-connected diodes. The ESD circuit may be compact and stackable (e.g., connected in series) to provide protection at higher turn-on voltages.

According to some embodiments, an electrostatic discharge protection circuit may comprise a first terminal, a second terminal, and a first diode stack connected between the first terminal and a control terminal of a first transistor. The protection circuit may further include a first current-carrying terminal of the first transistor coupled to the first terminal and a second current-carrying terminal of the first transistor coupled to the second terminal. In some aspects, an ESD protection circuit may further comprise a first shunt diode having a cathode connected to the first current-carrying terminal of the first transistor and an anode connected to the first terminal. The ESD protection circuit may also include a first base diode having a cathode connected to a control terminal of the first transistor and an anode connected to the first diode stack. In some implementations, an ESD protection circuit may further comprise a second diode stack connected between the second terminal and a control terminal of a second transistor, a first current-carrying terminal of the second transistor coupled to the second terminal, and a second current-carrying terminal of the second transistor coupled to the first terminal.

In some aspects, an ESD protection circuit may include a first shunt diode having a cathode connected to the first current-carrying terminal of the first transistor and an anode connected to the first terminal, a first base diode having a cathode connected to a control terminal of the first transistor and an anode connected to the first diode stack, a second shunt diode having a cathode connected to the first current-carrying terminal of the second transistor and an anode connected to the second terminal, and a second base diode having a cathode connected to a control terminal of the second transistor and an anode connected to the second diode stack. According to some aspects, the anode of the first base diode and anode of the second base diode are connected to a same node that is between the first diode stack and the second diode stack.

In some aspects, an ESD protection circuit may have a capacitance between the first terminal and second terminal less than 2 pF. In some implementations, the capacitance is less than 2 pF over a range of frequencies between approximately 0.1 GHz and approximately 12 GHz. According to some implementations, the first transistor and second transistor are heterojunction bipolar transistors. In some aspects, the heterojunction bipolar transistors comprise gallium arsenide. According to some aspects, the first shunt diode and the second shunt diode are Schottky diodes. In some cases, an ESD protection circuit may be formed on a semiconductor die within an area measuring less than 100 μm×100 μm.

In some implementations, the ESD protection circuit is connected to an input terminal of a gallium-nitride amplifier circuit and configured to protect the gallium-nitride amplifier circuit from excess voltages and/or excess power at its input. In some aspects, the ESD protection circuit protects the gallium-nitride amplifier circuit from power levels exceeding about 30 dBm.

In some embodiments, an electrostatic discharge protection circuit may comprise a first terminal, a second terminal, and a first circuit branch connected between the first terminal and the second terminal, wherein the first circuit branch includes a first shunt diode connected between a first current-carrying terminal of a first transistor and the first terminal. The protection circuit may further include a second circuit branch connected between the first terminal and the second terminal, wherein the second circuit branch includes a second shunt diode connected between a first current-carrying terminal of a second transistor and the second terminal. The first transistor may be configured to turn on when a voltage between the first terminal and second terminal exceeds a positive value, and the second transistor may be configured to turn on when a voltage between the first terminal and second terminal falls below a negative value. In some aspects, the absolute value of the negative value is approximately equal to the positive value.

In some aspects, the first terminal is connected to a radio-frequency input terminal of a gallium-nitride amplifier circuit. The first transistor and second transistor may be heterojunction bipolar transistors, and may comprise gallium arsenide.

In some implementations, an ESD protection circuit may further include a first base diode having a cathode connected to a control terminal of the first transistor and a first diode stack connected between the first terminal and an anode of the first base diode, wherein the positive value is determined at least in part by the first base diode and first diode stack. The ESD protection circuit may also include a second base diode having a cathode connected to a control terminal of the second transistor and a second diode stack connected between the second terminal and an anode of the second base diode, wherein the negative value is determined at least in part by the second base diode and second diode stack.

According to some aspects, an ESD protection circuit may have a capacitance between the first terminal and second terminal of less than 2 pF. The capacitance may be less than 2 pF over a range of frequencies between approximately 0.1 GHz and approximately 12 GHz.

In some implementations, an ESD protection circuit may be formed on a semiconductor die within an area measuring less than 100 μm×100 μm.

Methods of operating an electrostatic discharge protection circuit are also described. According to some embodiments, a method of operating an ESD circuit may comprise acts of receiving a voltage at a first terminal, applying the voltage across a first diode stack and a first base diode that are connected in series with a control terminal of a first transistor, turning on the first transistor if the voltage exceeds a first value, and shunting current through current-carrying terminals of the first transistor and a first shunt diode that are connected in series between the first terminal and a second terminal.

In some aspects, a method may further include applying the voltage across a second diode stack and a second base diode that are connected in series with a control terminal of a second transistor, turning on the second transistor if the voltage is less than a second value, and shunting current through current-carrying terminals of the second transistor and a second shunt diode between the first terminal and the second terminal. In some implementations, an absolute value of the second value is approximately equal to the first value. A method may further include shunting the current from a radio-frequency input of a gallium-nitride amplifier or other electronic circuit. In some cases, a method of operating an ESD protection circuit includes receiving the voltage as a time-varying signal that varies at one or more frequencies between approximately 0.1 GHz and approximately 12 GHz.

The foregoing apparatus and method embodiments may be included in any suitable combination with aspects, features, and acts described above or in further detail below. These and other aspects, embodiments, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the embodiments may be shown exaggerated or enlarged to facilitate an understanding of the embodiments. The drawings are not necessarily to scale, emphasis instead being placed upon illustrating the principles of the teachings. In the drawings, like reference characters generally refer to like features, functionally similar and/or structurally similar elements throughout the various figures. Where the drawings relate to microfabricated circuits, only one device and/or circuit may be shown to simplify the drawings. In practice, a large number of devices or circuits may be fabricated in parallel across a large area of a substrate or entire substrate. Additionally, a depicted device or circuit may be integrated within a larger circuit.

When referring to the drawings in the following detailed description, spatial references “top,” “bottom,” “upper,” “lower,” “vertical,” “horizontal,” “above,” “below” and the like may be used. Such references are used for teaching purposes, and are not intended as absolute references for embodied devices. An embodied device may be oriented spatially in any suitable manner that may be different from the orientations shown in the drawings. The drawings are not intended to limit the scope of the present teachings in any way.

FIG. 1 depicts a circuit schematic of an electrostatic discharge protection device, according to some embodiments;

FIG. 2 illustrates an electrostatic discharge pulse used for simulations of ESD protection, according to some embodiments;

FIG. 3A depicts an ESD voltage pulse waveform and resulting circuit responses, according to some embodiments;

FIG. 3B depicts current waveforms resulting from and ESD event, according to some embodiments;

FIG. 4 depicts a stacked ESD protection circuit, according to some embodiments;

FIG. 5 illustrates over-voltage protection provided by a stacked ESD circuit, according to some embodiments;

FIG. 6A depicts an integrated circuit having passive and active components that may be used for a gallium-nitride based amplifier, according to some embodiments;

FIG. 6B depicts incorporation of an integrated circuit having ESD protection circuits onto a pallet with other dies, according to some embodiments.

FIG. 7 illustrates over-voltage protection that may occur during amplification of a sinusoidal waveform, according to some embodiments;

FIG. 8 illustrates current flow through an ESD protection circuit during over-voltage protection, according to some embodiments;

FIG. 9 depicts a circuit for evaluating capacitance of an ESD protection circuit; and

FIG. 10 illustrates change in capacitance of a stacked ESD protection circuit as a function of RF bias.

Features and advantages of the illustrated embodiments will become more apparent from the detailed description set forth below when taken in conjunction with the drawings.

### DETAILED DESCRIPTION

Many electronic components, such as microchips, can be damaged by electrostatic discharge (ESD) events during manufacture, shipping, and while in service. Other circuit elements that may be damaged by ESD include parallel conductive traces separated by micrometer-scale distances or less, capacitors, and inductors. Thin, insulating dielectrics, such as gate dielectrics in MOS devices, are particularly susceptible to damage from ESD events, where a discharge can arc through the dielectric and create a shorting conductive path. During an electrostatic discharge event, voltages as high as 1000 volts or more may be delivered to a device or apparatus. In some cases, devices may damage at voltages as low as 25 volts. Therefore, sensitive components need to be protected from ESD events during manufacture, shipping, apparatus assembly, and while in service in an apparatus.

The inventor has recognized and appreciated that one way to protect a device from ESD is to fabricate, along with the device, integrated ESD protection circuitry that is configured to shunt over-voltages and/or currents away from sensitive circuitry. The inventor has recognized and appreciated that an ESD protection circuit should be compact, so that it does not occupy an appreciable amount of wafer or chip real estate. For example, it is preferable that an ESD protection circuit does not require more real estate than a circuit element or circuit which it protects. Additionally, an ESD protection circuit should provide over-voltage protection for both polarities of voltage.

In some implementations, it may be beneficial for an ESD protection circuit to have a low capacitance over a wide range of operating frequencies, and to activate symmetrically for positive and negative over-voltages. For example, such an ESD protection circuit may be useful for high-speed amplification of radio-frequency (RF) signals using gallium-nitride based power amplifiers. These amplifiers may operate on sinusoidal signals at frequencies up to approximately 12 GHz. In some embodiments, the amplifiers may operate at frequencies up to a value greater than 12 GHz, for example, up to 24 GHz. Low capacitance (e.g., less than about 2 picofarads) may be preferred to avoid appreciably changing a frequency characteristic of the amplifying circuit.

As used herein, the phrase “gallium nitride material” refers to gallium nitride (GaN) and any of its alloys, such as aluminum gallium nitride (AlxGa (1-x)N), indium gallium nitride (InyGa(1-y)N), aluminum indium gallium nitride (AlxInyGa(1-x-y)N), gallium arsenide phosporide nitride (GaAsxPy N(1-x-y)), aluminum indium gallium arsenide phosporide nitride (AlxInyGa(1-x-y)AsaPb N(1-a-b)), amongst others. Typically, when present, arsenic and/or phosphorous are at low concentrations (i.e., less than 5 percent by weight). In certain preferred embodiments, the gallium nitride material has a high concentration of gallium and includes little or no amounts of aluminum and/or indium. In high gallium concentration embodiments, the sum of (x+y) may be less than 0.4 in some implementations, less than 0.2 in some implementations, less than 0.1 in some implementations, or even less in other implementations. In some cases, it is preferable for at least one gallium nitride material layer to have a composition of GaN (i.e., x=y=a=b=0). For example, an active layer in which a channel is formed may have a composition of GaN. Gallium nitride materials may be doped n-type or p-type, or may be undoped. Suitable gallium nitride materials are described in U.S. Pat. No. 6,649,287, which is incorporated herein by reference in its entirety.

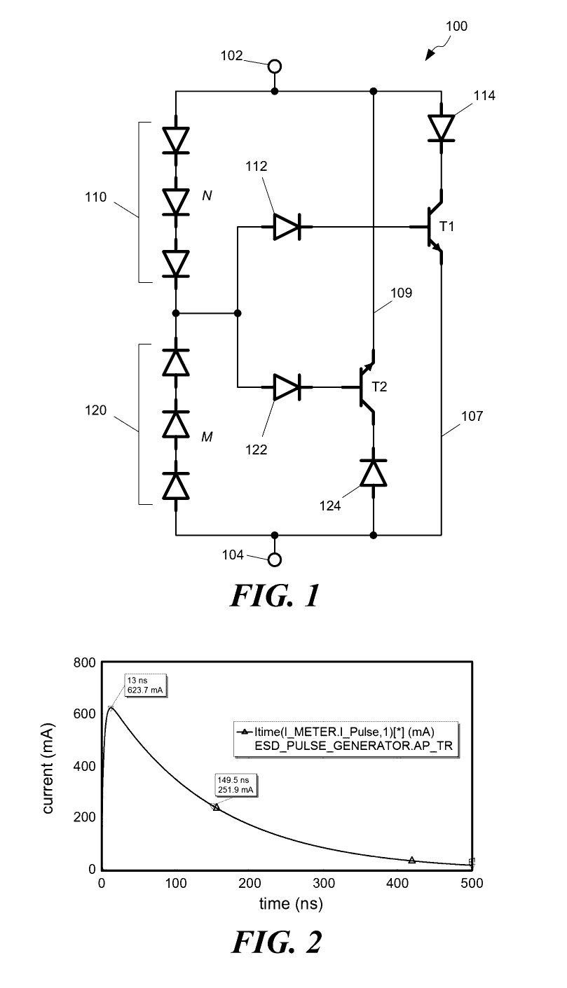

An example ESD protection circuit 100 is depicted in FIG. 1, according to some embodiments. In some embodiments, an ESD protection circuit 100 may include two circuit branches 107, 109 arranged in parallel to shunt over-voltages and/or over-currents between two terminals 102, 104 or nodes of a circuit. A first circuit 107 branch may include a first shunt diode 114 and a first transistor T1. A second circuit branch 109 may include a second shunt diode 124 and a second transistor T2. The ESD protection circuit 100 may further include a first diode stack 110 and a second diode stack 120. There may be a first base diode 112 connected between the first diode stack 110 and a control terminal of the first transistor T1. There may be a second base diode 122 connected between the second diode stack 120 and a control terminal of the second transistor T2.

According to some embodiments, the first transistor T1 and the second transistor T2 may comprise bipolar junction transistors, or heterojunction bipolar transistors. In some embodiments the first transistor and second transistor may comprise high electron mobility transistors or junction field effect transistors. Other transistor types may be used in other embodiments. In some implementations, transistors T1 and T2 are heterojunction bipolar transistors (HBTs) comprising gallium-arsenide material. The phrase “gallium-arsenide material” refers to gallium arsenide (GaAs) and any of its alloys (e.g., AlGaAs, InGaAs, etc.) A V_{be} turn-on voltage for transistors T1 and T2 may be between about 2.5 V and about 6 V, according to some embodiments. In some implementations, enhancement-mode pseudomorphic high-electron-mobility transistors (e.g., E-PHEMTs) may be used for transistors T1 and T2. In some cases, transistor T1 may differ from T2, if symmetric protection is not needed.

There may be N diodes in the first diode stack 110, and there may be M diodes in the second diode stack 120. In some cases, M=N. When M=N, the ESD protection circuit 100 may provide symmetric protection for over-voltage events. For example, the ESD protection circuit may activate (turn on T1 or T2) at positive or negative over-voltages having approximately the same magnitude to shunt the over-voltages and/or currents between the two terminals 102, 104. In some cases, M≠N. When M≠N, the ESD protection circuit 100 may provide asymmetric protection for over-voltage events. For example, the ESD protection circuit may activate for a positive voltage that is less than or greater than the magnitude of a negative voltage for which the ESD protection circuit activates. Base diode 112 may be a same diode as diodes in the first diode stack 110, and base diode 122 may be a same diode as the diodes in the second diode stack 120.

According to some embodiments, the diodes of the diode stack and base diodes may comprise gallium-nitride materials or gallium-arsenide materials. In some embodiments, stack diodes and base diodes may comprise semiconductor diodes having p-n junctions. In some implementations, stack diodes and/or base diodes may comprise Schottky diodes having metal-semiconductor junctions. According to some implementations, stack diodes and/or base diodes may comprise base-emitter or base-collector junctions of transistors. In some embodiments, the stack diodes and base diodes may have active areas between approximately 50 μm² and approximately 150 μm², and may have a turn-on voltage between about 0.5 V and about 1.5 V. In other embodiments, larger or smaller active areas may be used.

According to some embodiments shunt diode 114 and shunt diode 124 may be diodes having larger active areas than the stack and base diodes. The shunt diodes may comprise gallium-nitride materials or gallium-arsenide materials. In some embodiments, the shunt diodes may comprise semiconductor diodes having p-n junctions. In some implementations, the shunt diodes 114, 124 may comprise Schottky diodes having metal-semiconductor junctions. According to some implementations, shunt diodes may comprise base-emitter or base-collector junctions of transistors. An active area of a shunt diode may be between approximately 200 μm² and approximately 500 μm², according to some implementations. Other embodiments may have larger or smaller active areas for the shunt diodes. In various embodiments, shunt diodes 114, 124 are arranged to prevent high current, during a discharge event, from flowing through the base and collector of either transistor T1 or T2. For example, shunt diode 114 would be reverse biased when a high voltage (with respect to terminal 102) appears at the base contact of transistor T1.

In further detail, the diodes of the first diode stack 110 may be connected in series with base diode 112. A cathode of base diode 112 may connect to a control terminal (e.g., a base or gate terminal) of the first transistor T1. A first current-carrying terminal (e.g., a collector or drain terminal) of the first transistor T1 may connect to a cathode of the first shunt diode 114. An anode of the first shunt diode may connect to a first circuit terminal 102, and a second current-carrying terminal of the first transistor may connect to a second terminal 104.

Similarly, diodes of the second diode stack 120 may be connected in series with a second base diode 122. A cathode of the second base diode 122 may connect to a control terminal of the second transistor T2. A cathode of the second shunt diode 124 may connect to a first current-carrying terminal of the second transistor, and an anode of the shunt diode may connect to the second circuit terminal 104. A second current-carrying terminal of the second transistor T2 may connect to the first circuit terminal 102.

In operation, the ESD protection circuit 100 of FIG. 1 may protect any circuit or circuit element connected to the terminals 102, 104 from over-voltages and over-currents. When a positive over-voltage appears between the first terminal 102 and the second terminal 104 (e.g., the voltage at the first terminal exceeds the voltage at the second terminal by a predetermined amount), diodes of the first diode stack 110 and the base diode 112 will become forward biased so that a voltage appears at the control terminal of the first transistor T1. When the over-voltage appearing at the first terminal 102 exceeds the turn-on voltages of the series connected diodes in the first diode stack 110, the base diode 112, and the base-to-emitter turn-on voltage of the first transistor T1, then the first transistor T1 will turn on and conduct current between the first circuit terminal 102 and the second circuit terminal 104. Activation of the first transistor T1 effectively forms a short or shunt between the first terminal 102, through the first circuit branch 107, and to the second terminal 104.

When the voltage at the second terminal 104 exceeds the voltage at the first terminal 102 by a predetermined amount, then the diodes of the second diode stack 120 and the second base diode 122 may forward conduct to produce a voltage at the control terminal of the second transistor T2. At a high enough voltage, the second transistor T2 will turn on to provide a shunt through the second circuit branch 109 between the second terminal 104 and the first terminal 102. According to some embodiments, the turn-on voltage for transistor T1 may be between approximately 3 V and approximately 9 V. In some implementations, the turn-on voltage for transistor T1 is approximately 6 V. The turn-on voltage for transistor T2 may be between approximately −3 V and approximately −9 V. In some implementations, the turn-on voltage for transistor T2 is approximately −6 V. The voltage across terminals 102, 104 at which transistor T1 turns on may be referred to as a “forward activation voltage.” The voltage across terminals 102, 104 at which transistor T2 turns on may be referred to as a “reverse activation voltage.”

Simulations of the ESD protection circuit 100 were carried out using an ESD pulse having a current waveform depicted in FIG. 2. The peak voltage of the ESD pulse was approximately 1000 V. The current waveform of the ESD pulse was determined using a human body model. The current pulse shown in FIG. 2 rises to a value of approximately 625 mA within approximately 13 ns and then decays exponentially. For the simulations, the transistors were HBTs, the forward activation voltage was approximately 6 volts, and the reverse activation voltage was approximately −6 volts.

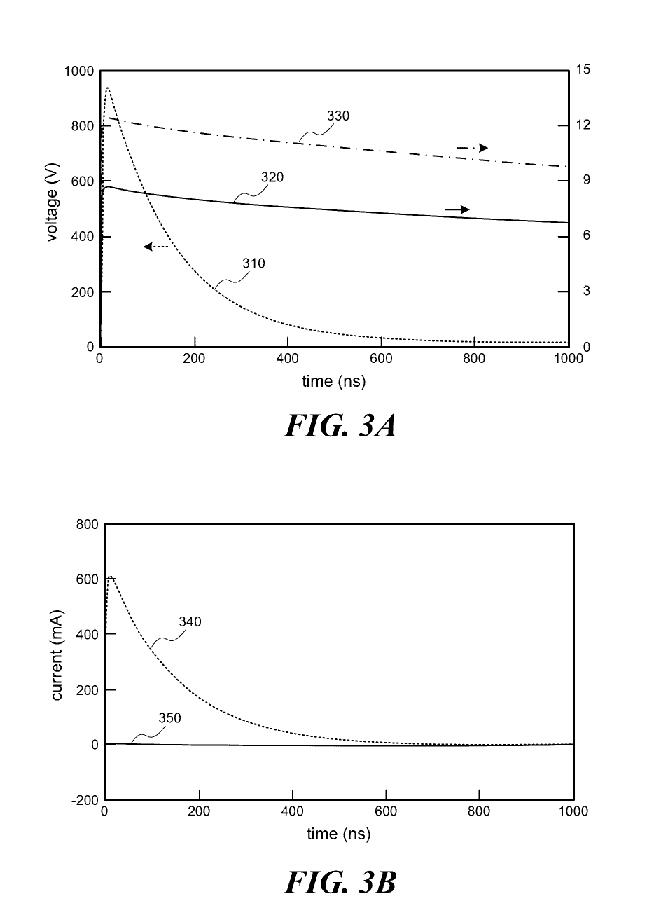

Results from simulations of an ESD discharge event into stacked ESD protection circuits are shown in FIG. 3A and FIG. 3B. For these simulations, two ESD protection circuits 100 were stacked in series between two reference potentials. In FIG. 3A, an ESD pulse waveform 310 is depicted as the dotted line. This pulse waveform was applied between the first terminal 102 and the second terminal 104 of the ESD protection circuit, and rises to a value of approximately 940 V in about 13.4 ns. Resulting voltage waveforms 320, 330 were measured at two locations in the ESD protection circuit, and are also plotted in FIG. 3A. The scale for the resulting voltage waveforms is on the right vertical axis of the graph.

A first voltage waveform 320 was measured at the base terminal of the first transistor T1, and is plotted as a solid line in FIG. 3A. This waveform shows that the voltage at the base of the transistor T1 reaches a value of almost 9 V at 14.9 ns. This peak voltage value occurs approximately 1.5 ns after the peak of the ESD pulse waveform 310. A second voltage waveform 330 was measured at the collector of the first transistor T1, and is shown as the dash-dotted line. The collector voltage reaches a peak value of approximately 12.5 V. Accordingly, the voltage at the first terminal 102 is suppressed to approximately 12.5 V within approximately 1.5 ns after the peak of a 1000-volt ESD event.

FIG. 3B plots current waveforms during an ESD event for the ESD protection circuit and same ESD event of FIG. 3A. The graph includes a current waveform 340 representative of current through the collector of the first transistor T1, shown as the dotted line. The collector current reaches a peak value of approximately 610 mA during the ESD event and then decays exponentially to half this value in approximately 120 ns. FIG. 3B also plots a current waveform 350 representative of current through the collector of the second transistor T2. By comparison with FIG. 2, most of the ESD current is discharged through the first transistor, while the second transistor remains off.

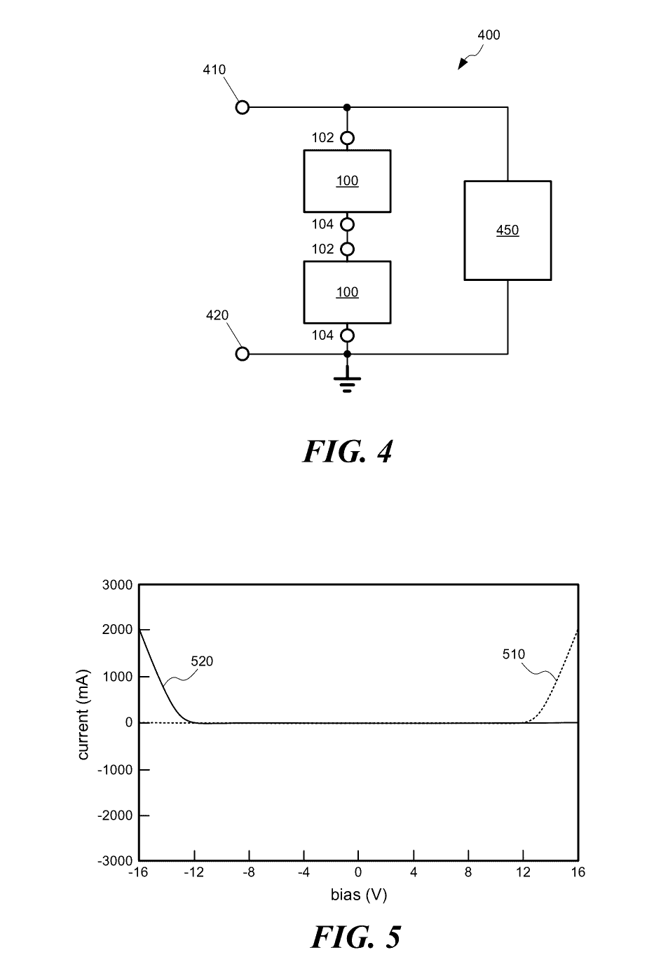

According to some embodiments, the ESD protection circuit 100 is compact and modular. For example, the ESD protection circuit may, in some embodiments, be stacked (connected in series) with one or more ESD protection circuits, as depicted in FIG. 4. ESD protection circuits may be stacked in some cases to increase activation voltages of the ESD protection circuit. For example, it may be desirable for a stacked ESD protection circuit 400 to turn on at a higher voltage across terminals 410, 420 than would occur for a single ESD protection circuit 100. According to some embodiments, ESD protection circuits 100 may be connected in series. As illustrated, combined ESD protection circuits 100 may be arranged to protect a device 450 from over-voltages and over-currents appearing across two terminals 410, 420. A device 450 may be a passive component, an active component, or an integrated circuit. In some embodiments, device 450 may be a gallium-nitride-based amplifier circuit.

Numerical simulations were carried out to evaluate over-voltage protection for a stacked ESD protection circuits 400 depicted in FIG. 4. Results from the simulations are shown in FIG. 5. For these simulations, the transistors in each ESD protection circuit were HBTs, and the activation voltages for each ESD protection circuit were ±6 V. Current through the collectors of the first transistors T1 and second transistors T2 were recorded while a voltage, applied between the terminals 410, 420, was swept between −16 V and 16 V.

A first current waveform 510, shown as a dotted line in FIG. 5, represents current flowing through a collector of a first transistor T1 in the ESD circuit 400. A second current waveform 520, shown as the solid line, represents current flowing through the collector of a second transistor T2. As can be seen from the graph, a forward activation voltage for the stacked ESD protection circuit is approximately +12 V, at which current begins to flow through the collectors of the first transistors T1. A reverse activation voltage for the stacked ESD protection circuit 400 is approximately −12 V. These activation voltages are approximately twice the activation voltages for a single ESD protection circuit 100. The leakage current was measured for the ESD circuit between ±8 V, and was found to be less than approximately 0.6 microamps. By stacking ESD protection circuits 100, protection over a larger range of operating voltages can be achieved. For example, the stacked ESD protection circuit 400 provides an operating voltage range of at least 20 volts (−10V to +10V). In some embodiments, a stacked ESD protection circuit provide an operating voltage range of at least 16 volts (−8V to +8V) and a leakage current less than 0.6 μA over that range. Other operating voltage ranges and leakage currents may be obtained by stacking more or fewer ESD protection circuits.

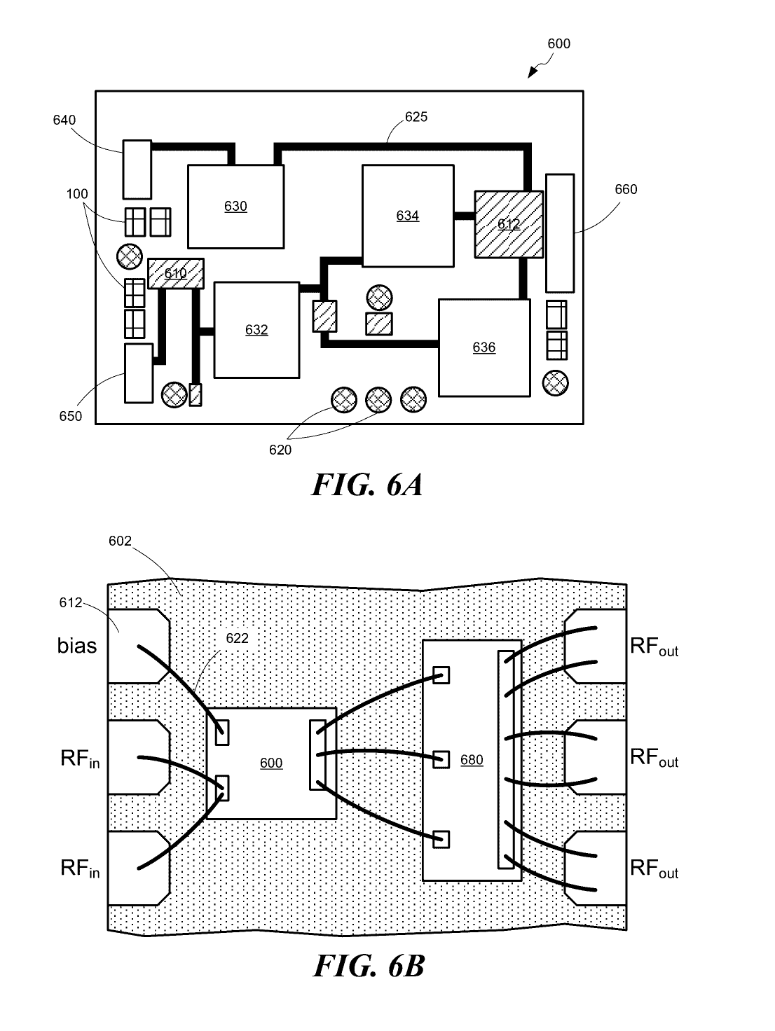

One benefit of an ESD protection circuit 100 is that it is compact in size and can be integrated onto a semiconductor die or chip, as depicted in FIG. 6A. The drawing depicts an input die 600 that includes passive and active components, and that may be used in an amplifier configuration. The input die may be fabricated using any suitable semiconductor, e.g., gallium arsenide or silicon germanium.

According to some embodiments, an input die 600 may comprise an input matching network for a gallium-nitride amplifier. In some embodiments, an input die 600 may include inductors 630, 632, 634, 636 and capacitors 610, 612 connected in an input circuit. The input die may also include one or more contact pads for coupling signals to and from the input circuit. For example, an input die may include a bias contact pad 640 for applying a voltage bias to power the input circuit (e.g., to bias a collector of one or more transistors). A second contact pad 650 may be included to apply an RF input signal that is to be amplified by a downstream amplifier (e.g., a gallium-nitride amplifier located on a separate die). A third contact pad 660 may be included to connect to a gate input of a gallium-nitride amplifier, for example. In some embodiments, the circuit may include through-level or through-chip vias 620 for connecting to one or more underlying conductive levels of the circuit. An input die 600 may include a plurality of conductive interconnects 625 for connecting the various components of the circuit.

According to some embodiments, one or more of the contact pads 640, 650, 660 may be protected by one or more ESD protection circuits 100, as depicted in the drawing. The electrical connections between the pads and protection circuits 100 are not shown to simplify the drawing. In some implementations, two ESD protection circuits are connected in series between a contact pad and a reference potential (e.g., a ground reference). In some cases, the drawing of FIG. 6A is approximately to scale, and shows that the ESD protection circuits 100 occupy a small amount of real estate compared to other passive components such as the inductors and capacitors. In some embodiments, an ESD protection circuit 100 occupies an area that is less than approximately 100 μm×100 μm.

The input die 600 may be included in a pallet 602, which may include two or more dies as depicted in FIG. 6B. For example, a gallium-nitride amplifier die 680 may also be included in the pallet. The pallet may include pallet pads 612, which may connect to conductive pins or tabs (not shown) of a packaged chip or device that includes the pallet. Electrical connections to external power sources and other circuits may be made through the pallet pads 612. The pallet pads may be connected to one or more contact pads on the pallet dies through wire bonds 622. Wire bonds may also be used to electrically connect one or more dies on the pallet, as depicted in the drawing.

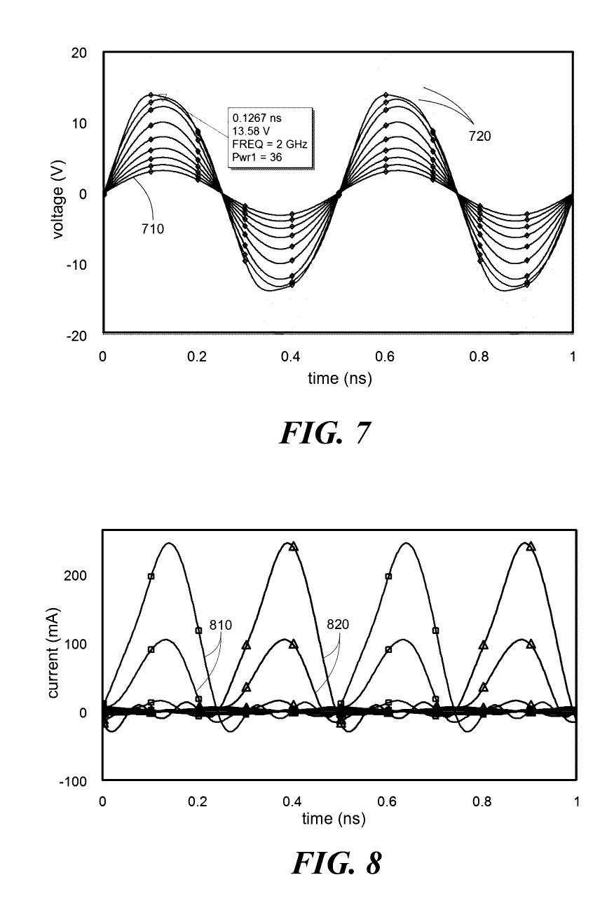

FIG. 7 depicts plots of a sinusoidal signal applied across a stacked ESD protection circuit 400 described above in connection with FIG. 4. The stacked ESD protection circuit 400 may be implemented, for example, to protect an RF input 640 of an amplifying circuit 680, as depicted in FIG. 6A and FIG. 6B. The plots of FIG. 7 correspond to different input power levels applied to the circuit. The power levels range from approximately 20 dBm to approximately 36 dBm in increments of 2 dBm. The frequency of the applied signal is approximately 2 GHz. The dark curves 710 represent the waveform received after the input protection circuit, e.g. at the first inductor 632. The light curves 720 for higher power levels represent the applied waveform values. As can be seen from FIG. 7, when the input power exceeds approximately 30 dBm, such that the voltage magnitude at the RF input 650 exceeds the activation voltage values of the stacked ESD circuit, the waveform becomes distorted and clipped. The distortion occurs because current and voltage are shunted by the stacked ESD circuit, which is activated due to the over-voltage condition appearing at the RF input 650. Accordingly, an ESD protection circuit can protect an RF amplifier 680 from over voltages or excess power (e.g., power levels greater than approximately 30 dBm) at its input that might otherwise damage the amplifier. Additionally, the protection can be achieved with an integrated ESD device that occupies less than approximately 100 μm×100 μm of a die's surface area.

FIG. 8 shows plots of currents flowing through collectors of transistors T1 and T2 of the ESD protection circuit 400, for the same applied power levels used in FIG. 7. The graph shows that at low input power levels, little current flows through the transistors T1 and T2. The current that flows through the transistors at low power levels (e.g., power levels corresponding to RF voltages between approximately ±8 V) represents a small amount of leakage current of the ESD protection circuit. At higher power levels, transistors T1 and T2 turn on during their respective forward conduction phases and allow current to shunt through the ESD protection circuit. The traces 810 marked by squares correspond to current flowing through transistor T1. The traces 820 marked by triangles correspond to current flowing through transistor T2. At a highest applied power level of 36 dBm, a peak current of approximately 250 mA shunts through transistors T1 and T2 on alternating half cycles of the RF signal.

Although an ESD protection circuit may be used to protect an input of an RF amplifier, it is important that the ESD circuit have a low capacitance, so that it does not appreciably alter an input impedance of an amplifier or other high-speed circuitry to which the ESD protection circuit is connected. In some embodiments, a capacitance of an ESD protection circuit is preferably less than 2 picofarads. In some implementations, a capacitance of an ESD protection circuit is preferably less than 1 picofarad. In some cases, a capacitance of an ESD protection circuit is preferably less than 0.5 picofarad.

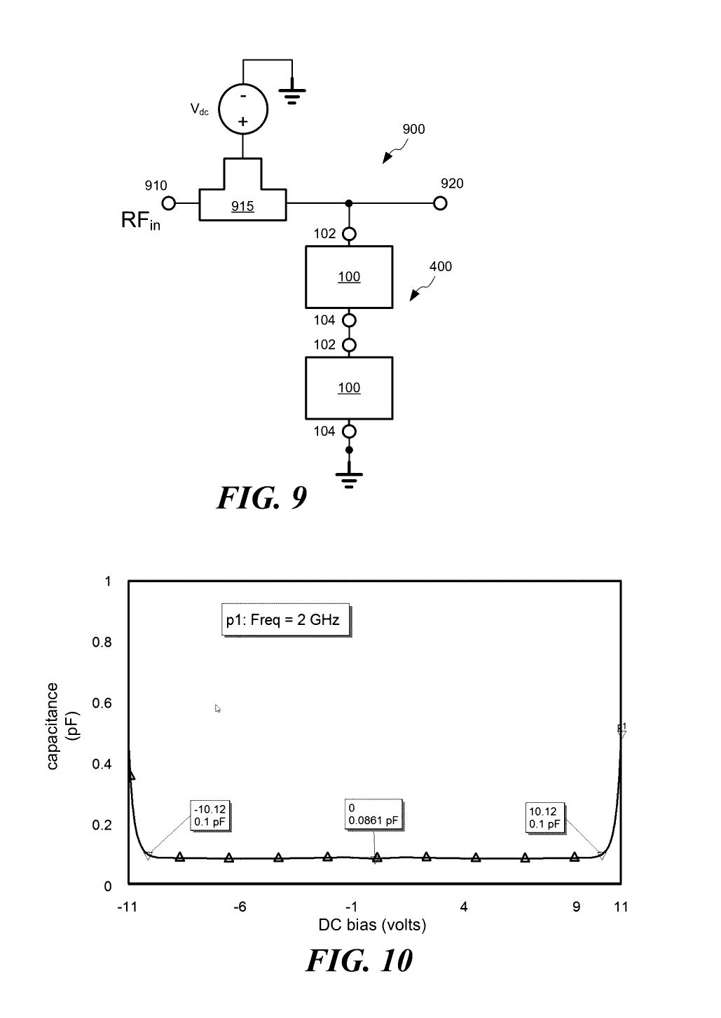

Capacitance of a stacked ESD protection circuit 400 was evaluated numerically with a test circuit 900 as depicted in FIG. 9. The stacked protection circuit 400 was connected between a first input port 910 and a reference potential (ground). A DC voltage source V_{dc} was connected through a bias T 915 to bias an input RF signal to the stacked ESD protection circuit. For the simulations, the value of V_{dc} was varied from −11 volts to +11 volts. An input port 910 and output port 920 each had an impedance of 50 ohms. Transistors T1 and T2 of the ESD protection circuits were gallium-arsenide HBTs, and the protection circuits each had activation voltages of approximately ±6 V. The RF input signal was sinusoidal, and its frequency was varied over a range of frequencies between about 100 MHz and about 12 GHz, while a signal from the output port 920 was monitored and processed to detect any changes in capacitance of the stacked ESD circuit. Results from one of the capacitance simulations are shown in FIG. 10. For this simulation, the RF frequency was fixed at 2 GHz. No appreciable change in capacitance was measured when the RF bias voltage V_{dc} was varied between about −10 volts and about 10 volts. Within this range of bias voltages, the capacitance of the ESD protection circuit remained at approximately 0.1 pF.

In a second simulation, the RF bias was held fixed at approximately −1.5 volts, while the RF frequency was varied between about 100 MHz and about 12 GHz. The bias voltage (e.g., −1.5 volts) may be a bias voltage used to bias field-effect transistors of amplifiers, in some embodiments. For this simulation, the observed capacitance remained at approximately 0.1 pF. Based on these results, it is expected that the ESD circuit may operate at frequencies up to at least 12 GHz. In some cases, it may operate at frequencies greater than 12 GHz, for example, up to about 24 GHz.

### CONCLUSION

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

The technology described herein may be embodied as a method, of which at least some acts have been described. The acts performed as part of the method may be ordered in any suitable way. Accordingly, embodiments may be constructed in which acts are performed in an order different than described, which may include performing some acts simultaneously, even though described as sequential acts in illustrative embodiments. Additionally, a method may include more acts than those described, in some embodiments, and fewer acts than those described in other embodiments.

Having thus described at least one illustrative embodiment of the invention, various alterations, modifications, and improvements will readily occur to those skilled in the art. Such alterations, modifications, and improvements are intended to be within the spirit and scope of the invention. Accordingly, the foregoing description is by way of example only and is not intended as limiting. The invention is limited only as defined in the following claims and the equivalents thereto.

What is claimed is:

1. An electrostatic discharge (ESD) protection circuit comprising:
a first terminal;
a second terminal;
a first diode stack connected between the first terminal and a control terminal of a first transistor;
a first current-carrying terminal of the first transistor coupled to the first terminal; and
a second current-carrying terminal of the first transistor coupled to the second terminal.

2. The ESD protection circuit of claim 1, further comprising:
a first shunt diode having a cathode connected to the first current-carrying terminal of the first transistor and an anode connected to the first terminal; and
a first base diode having a cathode connected to a control terminal of the first transistor and an anode connected to the first diode stack.

3. The ESD protection circuit of claim 1, further comprising:
a second diode stack connected between the second terminal and a control terminal of a second transistor;
a first current-carrying terminal of the second transistor coupled to the second terminal; and
a second current-carrying terminal of the second transistor coupled to the first terminal.

4. The ESD protection circuit of claim 3, further comprising:
a first shunt diode having a cathode connected to the first current-carrying terminal of the first transistor and an anode connected to the first terminal;
a first base diode having a cathode connected to a control terminal of the first transistor and an anode connected to the first diode stack;
a second shunt diode having a cathode connected to the first current-carrying terminal of the second transistor and an anode connected to the second terminal; and
a second base diode having a cathode connected to a control terminal of the second transistor and an anode connected to the second diode stack.

5. The ESD protection circuit of claim 4, having a capacitance between the first terminal and second terminal less than 2 pF.

6. The ESD protection circuit of claim 5, wherein the capacitance is less than 2 pF over a range of frequencies between approximately 0.1 GHz and approximately 12 GHz.

7. The ESD protection circuit of claim 4, formed on a semiconductor die within an area measuring less than 100 μm×100 μm.

8. The ESD protection circuit of claim 4, wherein the anode of the first base diode and anode of the second base diode are connected to a same node that is between the first diode stack and the second diode stack.

9. The ESD protection circuit of claim 4, wherein the first transistor and second transistor are heterojunction bipolar transistors.

10. The ESD protection circuit of claim 9, wherein the heterojunction bipolar transistors comprise gallium arsenide.

11. The ESD protection circuit of claim 4, wherein the first terminal is connected to an input terminal of a gallium-nitride amplifier circuit.

12. The ESD protection circuit of claim 4, wherein the first shunt diode and the second shunt diode are Schottky diodes.

13. An electrostatic discharge protection circuit comprising:
a first terminal;
a second terminal;
a first circuit branch connected between the first terminal and the second terminal, wherein the first circuit branch includes a first shunt diode connected between a first current-carrying terminal of a first transistor and the first terminal;
a second circuit branch connected between the first terminal and the second terminal, wherein the second circuit branch includes a second shunt diode connected between a first current-carrying terminal of a second transistor and the second terminal, wherein the protection circuit is configured to turn on the first transistor when a voltage between the first terminal and second terminal exceeds a positive value and the protection circuit is configured to turn on the second transistor when a voltage between the first terminal and second terminal falls below a negative value.

14. The ESD protection circuit of claim 13, wherein an absolute value of the negative value is approximately equal to the positive value.

15. The ESD protection circuit of claim 13, wherein the first terminal is connected to a radio-frequency input terminal of a gallium-nitride amplifier circuit.

16. The ESD protection circuit of claim 13, wherein the first transistor and second transistor are heterojunction bipolar transistors.

17. The ESD protection circuit of claim 16, wherein the heterojunction bipolar transistors comprise gallium arsenide.

18. The ESD protection circuit of claim 13, further comprising:
a first base diode having a cathode connected to a control terminal of the first transistor; and
a first diode stack connected between the first terminal and an anode of the first base diode, wherein the positive value is determined at least in part by the first base diode and first diode stack.

19. The ESD protection circuit of claim 18, further comprising:
a second base diode having a cathode connected to a control terminal of the second transistor; and
a second diode stack connected between the second terminal and an anode of the second base diode, wherein the negative value is determined at least in part by the second base diode and second diode stack.

20. The ESD protection circuit of claim 19, having a capacitance between the first terminal and second terminal of less than 2 pF.

21. The ESD protection circuit of claim 20, wherein the capacitance is less than 2 pF over a range of frequencies between approximately 0.1 GHz and approximately 12 GHz.

22. The ESD protection circuit of claim 19, formed on a semiconductor die within an area measuring less than 100 μm×100 μm.

23. A method of protecting a circuit, the method comprising:
receiving a voltage at a first terminal;
applying the voltage across a first diode stack and a first base diode that are connected in series with a control terminal of a first transistor;
turning on the first transistor if the voltage exceeds a first value; and
shunting current through current-carrying terminals of the first transistor and a first shunt diode between the first terminal and a second terminal.

24. The method of claim 23, further comprising:
applying the voltage across a second diode stack and a second base diode that are connected in series with a control terminal of a second transistor;
turning on the second transistor if the voltage is less than a second value; and
shunting current through current-carrying terminals of the second transistor and a second shunt diode between the first terminal and the second terminal.

25. The method of claim 24, wherein an absolute value of the second value is approximately equal to the first value.

26. The method of claim 24, further comprising shunting the current from a radio-frequency input of a gallium-nitride amplifier.

27. The method of claim 26, further comprising receiving the voltage as a time varying signal that varies at one or more frequencies between approximately 0.1 GHz and approximately 12 GHz.
